(19) United States
(12) Patent Application Publication
(10) Pub. No.: US 2025/0320338 A1
(43) Pub. Date: Oct. 16, 2025

(54) TRANSPARENT FILM, HARD COAT FILM, AND DISPLAY

(71) Applicant: KANEKA CORPORATION, Osaka (JP)

(72) Inventors: Yusuke Taguchi, Settsu-shi (JP); Keisuke Katayama, Settsu-shi (JP); Jun Kamite, Otsu-shi (JP); Satoshi Sugiyama, Settsu-shi (JP)

(73) Assignee: KANEKA CORPORATION, Osaka (JP)

(21) Appl. No.: 19/251,261

(22) Filed: Jun. 26, 2025

Related U.S. Application Data
(63) Continuation of application No. PCT/JP2023/046494, filed on Dec. 25, 2023.

(30) Foreign Application Priority Data
Dec. 27, 2022 (JP) 2022-209682
Jan. 25, 2023 (JP) 2023-009616

(51) Int. Cl. C08J 5/18; C08J 7/04; C08K 5/00; C08K 5/08; C08K 5/3475; C08K 5/3492; C08L 79/08; G02B 1/14

(52) U.S. Cl. CPC C08J 5/18; C08J 7/0427; C08K 5/0041; C08K 5/08; C08K 5/3475; C08K 5/3492; C08L 79/08; C08J 2379/08; C08J 2433/12; C08J 2435/02; C08J 2483/06; C08L 2203/16; G02B 1/14

(57) ABSTRACT

A transparent film including a polyimide-based resin and a bluing agent is provided. The transparent film has a total light transmittance of 90% or more. The transparent film optionally contains a resin other than the polyimide-based resin and/or an ultraviolet absorber. A yellowness index of the transparent film is optionally within the range of −1.0 or more and 1.0 or less. The transparent film has high total light transmittance and thus can be used suitably as a material for a display.

### TECHNICAL FIELD

One or more embodiments of the present invention relate to a transparent film containing a polyimide resin, a hard coat film, and a display.

### BACKGROUND

A film containing a transparent polyimide is excellent in mechanical strength, and is expected to be applied as a cover window of a flexible display. However, since a polyimide has a high refractive index and causes a lot of reflections of light (has a high reflectance) due to a refractive index difference with an air interface or an interface with another member, the transparent polyimide film has a small light transmittance, which causes a decrease in luminance of the display. In addition, since the absorption band overlaps a short wavelength region of visible light, the transparent polyimide is colored in yellow, has a high yellowness index, and may affect the hue (color tone) of the display.

Patent Document 1 proposes that the refractive index of a transparent polyimide film be reduced by blending silica particles having a low refractive index with a transparent polyimide. Patent Document 1 proposes that coloring of a transparent polyimide film be reduced by adding a bluing agent to a polyimide film or a hue adjusting layer provided on the polyimide film.

### PATENT DOCUMENTS

Patent Document 1: JP 2018-123319 A

To lower the refractive index of the polyimide film by using low refractive index particles such as silica, the amount of the particles needs to be increased, and the transparency and the mechanical strength may decrease because of poor dispersion of the particles. In addition, when a bluing agent is used for hue adjustment (yellowness index reduction), the light transmittance decreases because of light absorption of the bluing agent, and the transmittance improvement effect with the low refractive index particles may be lost.

### SUMMARY

In view of the above, a transparent film that contains a polyimide resin, is less colored, and has high light transmittance, is provided.

One or more embodiments of the present invention relate to a transparent film containing a polyimide-based resin and a bluing agent and having a total light transmittance of 90% or more. The transparent film may contain, in addition to the polyimide-based resin, a resin other than the polyimide-based resin as a resin component. The transparent film may contain an ultraviolet absorber.

The polyimide-based resin is a polyimide or a polyamideimide, and the resin includes a tetracarboxylic dianhydride-derived structure and a diamine-derived structure. As the resin other than the polyimide-based resin, an acryl-based resin may be preferable, and of these resins, a resin containing methyl methacrylate as a main component may be preferable.

The polyimide-based resin may contain an alicyclic tetracarboxylic dianhydride and a fluorine-containing aromatic tetracarboxylic dianhydride as a tetracarboxylic dianhydride, and may contain a fluorine-containing diamine as a diamine.

The content of the bluing agent of the transparent film may be 20 ppm or more. Examples of the bluing agent include blue pigments such as phthalocyanine-based compounds and ultramarine blue, and anthraquinone-based compounds.

The refractive index of the transparent film may be 1.6 or less. The yellowness index of the transparent film may be-1.0 or more and 1.0 or less. The transparent film may be a stretched film or may have refractive index anisotropy. The thickness of the transparent film may be 20 μm or more.

A functional layer such as a hard coat layer may be provided on the transparent film.

The transparent film of one or more embodiments of the present invention, containing a polyimide resin, has high mechanical strength and high total light transmittance. Thus, the transparent film can be suitably used as a material for a display.

### DETAILED DESCRIPTION

### [Transparent Film]

The transparent film of one or more embodiments of the present invention contains one or more polyimide-based resins selected from the group consisting of a polyimide and a polyamideimide, and a bluing agent. The transparent film may contain a resin other than the polyimide-based resin (hereinafter, it may be referred to as “another resin”) as a resin component in addition to the polyimide-based resin from the viewpoint of reducing the refractive index, improving the transparency, and the like.

### <Polyimide-Based Resin>

The polyimide is obtained by dehydrocyclization of a polyamic acid that is obtained by reaction of tetracarboxylic dianhydride (hereinafter, it may be referred to as “acid dianhydride”) and diamine. The polyamideimide is obtained by replacing a part of tetracarboxylic dianhydride of the polyimide with dicarboxylic acid derivative such as dicarboxylic acid dichloride. As the polyimide-based resin, a polyimide and a polyamideimide may be used in combination. From the viewpoint of compatibility with another resin and the like, polyimide may be preferable as the polyimide-based resin.

### (Tetracarboxylic Dianhydride)

The polyimide-based resin used in the present embodiment may contain an alicyclic tetracarboxylic dianhydride as an acid dianhydride component. The acid dianhydride component having an alicyclic structure tends to improve the compatibility between the polyimide-based resin and another resin. The alicyclic tetracarboxylic dianhydride is only required to have at least one alicyclic structure, and may have both an alicyclic ring and an aromatic ring in one molecule. The alicyclic ring may be polycyclic, or may have a spiro structure.

Examples of the alicyclic tetracarboxylic dianhydride include 1,2,3,4-cyclobutanetetracarboxylic dianhydride, 1,2,3,4-cyclopentanetetracarboxylic dianhydride, 1,3-dimethylcyclobutane-1,2,3,4-tetracarboxylic dianhydride, 1,2,3,4-tetramethyl-1,2,3,4-cyclobutanetetracarboxylic dianhydride, 1,2,4,5-cyclohexanetetracarboxylic dianhydride, 1,2,3,4-butanetetracarboxylic dianhydride, meso-butane-1,2,3,4-tetracarboxylic dianhydride, 1,1′-bicyclohexane-3,3′,4,4′-tetracarboxylic-3,4: 3′,4′-dianhydride, norbornane-2-spiro-α-cyclopentanone-α′-spiro-2″-norbornane-5,5″,6,6″-tetracarboxylic dianhydride, 2,2′-binorbornane-5,5′,6,6′-tetracarboxylic dianhydride, 3-(carboxymethyl)-1,2,4-cyclopentanetricarboxylic acid 1,4:2,3-dianhydride, bicyclo[2.2.2]octa-7-ene-2,3,5,6-tetracarboxylic dianhydride, 4-(2,5-dioxotetrahydrofuran-3-yl)-1,2,3,4-tetrahydronaphthalene-1,2-dicarboxylic anhydride, cyclohexane-1,4-diylbis(methylene)bis(1,3-dioxo-1,3-dihydroisobenzofuran-5-carboxylate), 5-(2,5-dioxotetrahydrofuryl)-3-methyl-3-cyclohexene-1,2-dicarboxylic anhydride, 5,5′-[cyclohexylidenebis(4,1-phenyleneoxy)]bis-1,3-isobenzofurandione, 5-isobenzofurancarboxylic acid, 1,3-dihydro-1,3-dioxo-5,5′-[1,4-cyclohexanediylbis(methylene)]ester, bicyclo[2.2.1]heptane-2,3,5,6-tetracarboxylic dianhydride, bicyclo[2.2.2]octane-2,3,5,6-tetracarboxylic dianhydride, 3,5,6-tricarboxynorbornane-2-acetic acid 2,3:5,6-dianhydride, decahydro-1,4,5,8-dimethanonaphthalene-2,3,6,7-tetracarboxylic dianhydride, tricyclo[6.4.0.0 (2,7)]dodecane-1,8:2,7-tetracarboxylic dianhydride, octahydro-1H,3H,8H, 10H-biphenyleno [4a,4bc: 8a,8b-c′]difuran-1,3,8,10-tetron, ethylene glycol bis(hydrogenated trimellitic anhydride) ester, and decahydro [2]benzopyrano [6,5,4,-def][2]benzopyran-1,3,6,8-tetrone. Among the alicyclic tetracarboxylic dianhydrides, from the viewpoint of the transparency and mechanical strength of the polyimide-based resin, 1,2,3,4-cyclobutanetetracarboxylic dianhydride (CBDA), 1,2,3,4-cyclopentanetetracarboxylic dianhydride (CPDA), 1,2,4,5-cyclohexanetetracarboxylic dianhydride (H-PMDA) or 1,1′-bicyclohexane-3,3′,4,4′-tetracarboxylic acid-3,4: 3′,4′-dianhydride (H-BPDA) may be preferable, and 1,2,3,4-cyclobutanetetracarboxylic dianhydride may be preferable.

From the viewpoint of improving the compatibility between the polyimide-based resin and another resin, the content of the alicyclic tetracarboxylic dianhydride with respect to 100 mol % of all acid dianhydride components may be 1 mol % or more, 3 mol % or more, 5 mol % or more, 6 mol % or more, 7 mol % or more, 8 mol % or more, 9 mol % or more, 10 mol % or more, 12 mol % or more, or 15 mol % or more. The amount of the alicyclic tetracarboxylic dianhydride required for imparting the compatibility with another resin may vary depending on, for example, the type of another resin and the type of the alicyclic tetracarboxylic dianhydride. For example, when the alicyclic tetracarboxylic dianhydride is 1,2,3,4-cyclobutanetetracarboxylic dianhydride (CBDA), the content of CBDA with respect to 100 mol % of all acid dianhydride components may be 6 mol % or more, 8 mol % or more, or 10 mol % or more.

From the viewpoint of securing the solubility of the polyimide-based resin in an organic solvent, the content of the alicyclic tetracarboxylic dianhydride with respect to 100 mol % of all acid dianhydride components may be 80 mol % or less, 78 mol % or less, 76 mol % or less, 74 mol % or less, 72 mol % or less, 70 mol % or less, 65 mol % or less, 60 mol % or less, 55 mol % or less, or 50 mol % or less. To make the polyimide-based resin soluble in a low-boiling-point halogen-based solvent such as methylene chloride, the content of the alicyclic tetracarboxylic dianhydride may be 45 mol % or less, 40 mol % or less, or 35 mol % or less.

From the viewpoint of making the polyimide-based resin soluble in an organic solvent, it may be preferable to contain a fluorine-containing aromatic tetracarboxylic dianhydride or/and a bis(trimellitic anhydride) ester as the acid dianhydride component in addition to the alicyclic tetracarboxylic dianhydride.

Examples of the fluorine-containing aromatic tetracarboxylic dianhydride include 2,2-bis(3,4-dicarboxyphenyl)-1,1,1,3,3,3-hexafluoropropanoic dianhydride and 2,2-bis{4-[4-(1,2-dicarboxy)phenoxy]phenyl}-1,1,1,3,3,3-hexafluoropropanoic dianhydride.

Examples of the bis(trimellitic anhydride) ester include bis(1,3-dioxo-1,3-dihydroisobenzofuran-5-carboxylic acid)-2,2′,3,3′,5,5′-hexamethylbiphenyl-4,4′-diyl (TAHMBP).

From the viewpoint of making the polyimide-based resin soluble in an organic solvent, the total content of the fluorine-containing aromatic tetracarboxylic dianhydride and the bis(trimellitic anhydride) ester with respect to 100 mol % of the total amount of the acid dianhydride components may be 15 mol % or more, 20 mol % or more, 25 mol % or more, 30 mol % or more, 35 mol % or more, 40 mol % or more, 45 mol % or more, or 50 mol % or more. The total content of the fluorine-containing aromatic tetracarboxylic dianhydride and the bis(trimellitic anhydride) ester with respect to 100 mol % of the total amount of the acid dianhydride components may be 99 mol % or less, 95 mol % or less, 90 mol % or less, 85 mol % or less, 80 mol % or less, 75 mol % or less, or 70 mol % or less.

From the viewpoint of obtaining a polyimide-based resin having both solubility in an organic solvent and compatibility with another resin, the total content of the alicyclic tetracarboxylic dianhydride, the fluorine-containing aromatic tetracarboxylic dianhydride, and the bis(trimellitic anhydride) ester with respect to 100 mol % of the total amount of the acid dianhydride components may be 50 mol % or more, 60 mol % or more, 65 mol % or more, 70 mol % or more, 75 mol % or more, 80 mol % or more, 85 mol % or more, 90 mol % or more, or 95 mol % or more.

The polyimide-based resin may contain, as the acid dianhydride component, an acid dianhydride other than the alicyclic tetracarboxylic dianhydride, the fluorine-containing aromatic tetracarboxylic dianhydride, and the bis(trimellitic anhydride) ester. Examples of the acid dianhydride other than the above include: ethylene tetracarboxylic dianhydride, butanetetracarboxylic dianhydride, 3,3′,4,4′-benzophenone tetracarboxylic dianhydride, 2,2′,3,3′-benzophenone tetracarboxylic dianhydride, 2,2′,3,3′-biphenyltetracarboxylic dianhydride, pyromellitic dianhydride, 3,3′,4,4′-biphenyltetracarboxylic dianhydride, 2,2-bis(3,4-dicarboxyphenyl) propane dianhydride, 2,2-bis(2,3-dicarboxyphenyl) propane dianhydride, bis(3,4-dicarboxyphenyl) ether dianhydride, bis(3,4-dicarboxyphenyl) sulfone dianhydride, 1,1-bis(2,3-dicarboxyphenyl)ethane dianhydride, bis(2,3-dicarboxyphenyl) methane dianhydride, bis(3,4-dicarboxyphenyl) methane dianhydride, 9,9-bis(3,4-dicarboxyphenyl) fluorene dianhydride, 1,3-bis[(3,4-dicarboxy)benzoyl]benzene dianhydride, 1,4-bis[(3,4-dicarboxy)benzoyl]benzene dianhydride, 2,2-bis{4-[4-(1,2-dicarboxy)phenoxy]phenyl}propane dianhydride, 2,2-bis{4-[4-(3,4-dicarboxy)phenoxy]phenyl}propane dianhydride, 2,2-bis{4-[3-(1,2-dicarboxy)phenoxy]phenyl}propane dianhydride, bis{4-[4-(1,2-dicarboxy)phenoxy]phenyl}ketone dianhydride, bis{4-[3-(1,2-dicarboxy)phenoxy]phenyl}ketone dianhydride, 4,4′-bis[4-(1,2-dicarboxy)phenoxy]biphenyl dianhydride, 4,4′-bis[3-(1,2-dicarboxy)phenoxy]biphenyl dianhydride, bis{4-[4-(1,2-dicarboxy)phenoxy]phenyl}ketone dianhydride, bis{4-[3-(1,2-dicarboxy)phenoxy]phenyl}ketone dianhydride, bis{4-[4-(1,2-dicarboxy)phenoxy]phenyl}sulfone dianhydride, bis{4-[3-(1,2-dicarboxy)phenoxy]phenyl}sulfone dianhydride, bis{4-[4-(1,2-dicarboxy)phenoxy]phenyl}sulfide dianhydride, bis{4-[3-(1,2-dicarboxy)phenoxy]phenyl}sulfide dianhydride, 2,3,6,7-naphthalenetetracarboxylic dianhydride, 1,4,5,8-naphthalenetetracarboxylic dianhydride, 1,2,5,6-naphthalenetetracarboxylic dianhydride, 1,2,3,4-benzenetetracarboxylic dianhydride, 3,4,9,10-perylene tetracarboxylic dianhydride, 2,3,6,7-anthracenetetracarboxylic dianhydride, 1,2,7,8-phenanthrene-tetracarboxylic dianhydride, and bis(1,3-dihydro-1,3-dioxo-5-isobenzofurancarboxylic acid)-1,4-phenylene ester.

### (Dicarboxylic Acid)

As described above, the polyimide-based resin may be a polyamideimide in which a part of the tetracarboxylic acid dianhydride component is replaced with a dicarboxylic acid derivative. Examples of the dicarboxylic acid include: aliphatic dicarboxylic acids such as adipic acid, suberic acid, azelaic acid, sebacic acid, and dodecanedioic acid; aromatic dicarboxylic acids such as terephthalic acid, isophthalic acid, 2-chloroterephthalic acid, 2-methylterephthalic acid, 5-methylisophthalic acid, 2,6-naphthalenedicarboxylic acid, 4,4′-oxybisbenzoic acid, 4,4′-biphenyldicarboxylic acid, and 2-fluoroterephthalic acid; alicyclic dicarboxylic acids such as 1,4-cyclohexanedicarboxylic acid, 1,3-cyclohexanedicarboxylic acid, 1,2-hexahydroterephthalic acid, hexahydroisophthalic acid, 1,3-cyclopentanedicarboxylic acid, and bi (cyclohexyl)-4,4′-dicarboxylic acid; and heterocyclic dicarboxylic acids such as 2,5-thiophene dicarboxylic acid and 2,5-furandicarboxylic acid.

From the viewpoint of the solubility of the polyamideimide and compatibility with another resin, the dicarboxylic acid may be an aromatic dicarboxylic acid or an alicyclic dicarboxylic acid, or an aromatic dicarboxylic acid. Among aromatic dicarboxylic acids, terephthalic acid, isophthalic acid, 4,4′-biphenyl dicarboxylic acid, and 4,4′-oxybisbenzoic acid may be preferable, and of these, terephthalic acid and isophthalic acid may be preferable, and terephthalic acid may be preferable.

As the dicarboxylic acid derivative used as a raw material monomer of the polyamideimide, dicarboxylic acid derivatives such as dicarboxylic acid dichloride, dicarboxylic acid ester, and dicarboxylic acid anhydride are used. Of these, a dicarboxylic acid dichloride may be preferable because of its high reactivity.

From the viewpoint of the solubility of the polyamideimide and compatibility with another resin, the proportion of the dicarboxylic acid derivative to the total of the tetracarboxylic acid dianhydride and the dicarboxylic acid derivative may be 40 mol % or less, 35 mol % or less, or 30 mol % or less. The polyimide-based resin may be a polyimide in which the proportion of the dicarboxylic acid derivative is 0 (that is, containing no structure derived from the dicarboxylic acid derivative).

### (Diamine)

The diamine component of the polyimide-based resin used in the present embodiment is not particularly limited. From the viewpoint of solubility, the diamine of the polyimide-based resin may have one or more selected from the group consisting of a fluorine group, a trifluoromethyl group, a sulfone group, a fluorene structure, and an alicyclic structure. Of these, from the viewpoint of achieving both the solubility and the transparency of the polyimide-based resin, the polyimide-based resin may contain a fluorine-containing diamine such as fluoroalkyl-substituted benzidine as the diamine component.

Examples of the fluoroalkyl-substituted benzidine as the fluorine-containing diamine include 2-(trifluoromethyl)benzidine, 3-(trifluoromethyl)benzidine, 2,3-bis(trifluoromethyl)benzidine, 2,5-bis(trifluoromethyl)benzidine, 2,6-bis(trifluoromethyl)benzidine, 2,3,5-tris(trifluoromethyl)benzidine, 2,3,6-tris(trifluoromethyl)benzidine, 2,3,5,6-tetrakis(trifluoromethyl)benzidine, 2,2′-bis(trifluoromethyl)benzidine, 3,3′-bis(trifluoromethyl)benzidine, 2,3′-bis(trifluoromethyl)benzidine, 2,2′,3-bis(trifluoromethyl)benzidine, 2,3,3′-tris(trifluoromethyl)benzidine, 2,2′,5-tris(trifluoromethyl)benzidine, 2,2′,6-tris(trifluoromethyl)benzidine, 2,3′,5-tris(trifluoromethyl)benzidine, 2,3′,6,-tris(trifluoromethyl)benzidine, 2,2′,3,3′-tetrakis(trifluoromethyl)benzidine, 2,2′,5,5′-tetrakis(trifluoromethyl)benzidine, and 2,2′,6,6′-tetrakis(trifluoromethyl)benzidine.

Of these, a fluoroalkyl-substituted benzidine having a fluoroalkyl group at the 2-position of biphenyl may be preferable, and 2,2′-bis(trifluoromethyl)benzidine (hereinafter, referred to as “TFMB”) may be preferable. When fluoroalkyl groups are present at the 2-position and 2′-position of biphenyl, the π-electron density decreases because of the electron-attracting property of the fluoroalkyl group, and a bond between two benzene rings of biphenyl is twisted by steric hindrance of the fluoroalkyl group, leading to a decrease in planarity of the π-conjugate. Thus, the absorption edge wavelength shifts to a short wave, and thus coloring of the polyimide-based resin can be suppressed.

The content of the fluoroalkyl-substituted benzidine with respect to 100 mol % of the total amount of the diamine components may be 50 mol % or more, 60 mol % or more, 70 mol % or more, 80 mol % or more, 85 mol % or more, or 90 mol % or more. A large content of the fluoroalkyl-substituted benzidine tends to lead to suppression of coloring of the film and enhancement of mechanical strength in terms of pencil hardness, tensile modulus and the like.

The polyimide-based resin may contain a diamine other than the fluoroalkyl-substituted benzidine as the diamine component. Examples of the diamine other than fluoroalkyl-substituted benzidine include p-phenylenediamine, m-phenylenediamine, o-phenylenediamine, 3,3′-diaminodiphenyl ether, 3,4′-diaminodiphenyl ether, 4,4′-diaminodiphenyl ether, 3,3′-diaminodiphenyl sulfide, 3,4′-diaminodiphenyl sulfide, 4,4′-diaminodiphenyl sulfide, 3,3′-diaminodiphenylsulfone, 3,4′-diaminodiphenylsulfone, 4,4′-diaminodiphenylsulfone, 9,9-bis(4-aminophenyl) fluorene, 3,3′-diaminobenzophenone, 4,4′-diaminobenzophenone, 3,4′-diaminobenzophenone, 3,3′-diaminodiphenylmethane, 4,4′-diaminodiphenylmethane, 3,4′-diaminodiphenylmethane, 2,2-di(3-aminophenyl) propane, 2,2-di(4-aminophenyl) propane, 2-(3-aminophenyl)-2-(4-aminophenyl) propane, 1,1-di(3-aminophenyl)-1-phenylethane, 1,1-di(4-aminophenyl)-1-phenylethane, 1-(3-aminophenyl)-1-(4-aminophenyl)-1-phenylethane, 1,3-bis(3-aminophenoxy)benzene, 1,3-bis(4-aminophenoxy)benzene, 1,4-bis(3-aminophenoxy)benzene, 1,4-bis(4-aminophenoxy)benzene, 1,3-bis(3-aminobenzoyl)benzene, 1,3-bis(4-aminobenzoyl)benzene, 1,4-bis(3-aminobenzoyl)benzene, 1,4-bis(4-aminobenzoyl)benzene, 1,3-bis(3-amino-α,α-dimethylbenzyl)benzene, 1,3-bis(4-amino-α,α-dimethylbenzyl)benzene, 1,4-bis(3-amino-α,α-dimethylbenzyl)benzene, 1,4-bis(4-amino-α,α-dimethylbenzyl)benzene, 2,6-bis(3-aminophenoxy)benzonitrile, 2,6-bis(3-aminophenoxy)pyridine, 4,4′-bis(3-aminophenoxy) biphenyl, 4,4′-bis(4-aminophenoxy) biphenyl, bis[4-(3-bis[4-(4-aminophenoxy)phenyl]ketone, bis[4-(3-aminophenoxy)phenyl]ketone, bis[4-(3-aminophenoxy)phenyl]sulfide, -bis[4-(4-aminophenoxy)phenyl]sulfide, bis[4-(3aminophenoxy)phenyl]ether, bis[4-(4-aminophenoxy)phenyl]sulfone, bis[4-(3aminophenoxy)phenyl]propane, 2,2-bis[4-(4-aminophenoxy)phenyl]propane, 1,3-bis[4-(3aminophenoxy)benzoyl]benzene, 1,3-bis[4-(4-aminophenoxy)benzoyl]benzene, 1,4-bis[4-(3-aminophenoxy)benzoyl]benzene, 1,4-bis[4-(4-aminophenoxy)benzoyl]benzene, 1,3-bis[4-(3-aminophenoxy)-α,α-dimethylbenzyl]benzene, 1,3-bis[4-(4-aminophenoxy)-α,α-dimethylbenzyl]benzene, 1,4-bis[4-(3-aminophenoxy)-α,α-dimethylbenzyl]benzene, 1,4-bis[4-(4-aminophenoxy)-α,α-dimethylbenzyl]benzene, 4,4′-bis[4-(4-aminophenoxy)benzoyl]diphenyl ether, 4,4′-bis[4-(4-amino-α,α-dimethylbenzyl) phenoxy]benzophenone, 4,4′-bis[4-(4-amino-α,α-dimethylbenzyl)phenoxy]diphenylsulfone, 4,4′-bis[4-(4-aminophenoxy)phenoxy]diphenylsulfone, 3,3′-diamino-4,4′-diphenoxybenzophenone, 3,3′-diamino-4,4′-dibiphenoxybenzophenone, 3,3′-diamino-4-phenoxybenzophenone, 3,3′-diamino-4-biphenoxybenzophenone, 6,6′-bis(3-aminophenoxy)-3,3,3′,3′-tetramethyl-1, l′-spirobiindane, 6,6′-bis(4-aminophenoxy)-3,3,3′,3′-tetramethyl-1, l′-spirobiindane, 1,3-bis(3-aminopropyl)tetramethyldisiloxane, 1,3-bis(4-aminobutyl)tetramethyldisiloxane, α,ω-bis(3-aminopropyl) polydimethylsiloxane, α,ω-bis(3-aminobutyl) polydimethylsiloxane, bis(aminomethyl) ether, bis(2-aminoethyl) ether, bis(3-aminopropyl) ether, bis(2-aminomethoxy)ethyl]ether, bis[2-(2-aminoethoxy)ethyl]ether, bis[2-(3-aminoprotoxy)ethyl] ether, 1,2-bis(aminomethoxy)ethane, 1,2-bis(2-aminoethoxy)ethane, 1,2-bis[2-(aminomethoxy) ethoxy]ethane, 1,2-bis[2-(2-aminoethoxy) ethoxy] ethane, ethylene glycol bis(3-aminopropyl) ether, cyclohexane, 1,3-di(2-aminoethyl)cyclohexane, 1,4-di(2-aminoethyl)cyclohexane, bis(4-aminocyclohexyl) methane, 2,6-bis(aminomethyl) bicyclo[2.2.1]heptane, 2,5-bis(aminomethyl) bicyclo[2.2.1]heptane, 1,4-diamino-2-fluorobenzene, 1,4-diamino-2,3-difluorobenzene, 1,4 diamino-2,5-difluorobenzene, 1,4-diamino-2,6-difluorobenzene, 1,4-diamino-2,3,5-trifluorobenzene, 1,4-diamino-2,3,5,6-tetrafluorobenzene, 1,4-diamino-2-(trifluoromethyl)benzene, 1,4-diamino-2,3-bis(trifluoromethyl)benzene, 1,4-diamino-2,5-bis(trifluoromethyl)benzene, 1,4-diamino-2,6-bis(trifluoromethyl)benzene, 1,4-diamino-2,3,5-tris(trifluoromethyl)benzene, 1,4-diamino-2,3,5,6-tetrakis(trifluoromethyl)benzene, 2,2′-dimethylbenzidine, 2-fluorobenzidine, 3-fluorobenzidine, 2,3-difluorobenzidine, 2,5-difluorobenzidine, 2,6-difluorobenzidine, 2,3,5-trifluorobenzidine, 2,3,6-trifluorobenzidine, 2,3,5,6-tetrafluorobenzidine, 2,2′-difluorobenzidine, 3,3′-difluorobenzidine, 2,3′-difluorobenzidine, 2,2′,3-trifluorobenzidine, 2,3,3′-trifluorobenzidine, 2,2′,5-trifluorobenzidine, 2,2′, 6-trifluorobenzidine, 2,3′,5-trifluorobenzidine, 2,3′,6-trifluorobenzidine, 2,2′,3,3′-tetrafluorobenzidine, 2,2′,5,5′-tetrafluorobenzidine, 2,2′, 6,6′-tetrafluorobenzidine, 2,2′,3,3′,6,6′-hexafluorobenzidine, and 2,2′,3,3′,5,5′,6,6′-octafluorobenzidine. For example, by using diaminodiphenylsulfone as the diamine in addition to the fluoroalkyl-substituted benzidine, the solvent-solubility and transparency of the polyimide-based resin may be improved. Among the diaminodiphenylsulfones, 3,3′-diaminodiphenylsulfone (3,3′-DDS) and 4,4′-diaminodiphenylsulfone (4,4′-DDS) may be preferable. 3,3′-DDS and 4,4′-DDS may be used in combination. The content of diaminodiphenylsulfone with respect to 100 mol % of all diamines may be 1 to 40 mol %, 3 to 30 mol %, or 5 to 25 mol %.

### (Preparation of Polyimide-Based Resin)

A polyamic acid as a polyimide precursor is obtained through the reaction between the acid dianhydride and the diamine, and the polyimide is obtained through cyclodehydration (imidization) of the polyamic acid. A method for preparing the polyamic acid is not particularly limited, and any known method can be used. For example, a polyamic acid solution is obtained by dissolving the diamine and the tetracarboxylic dianhydride in an organic solvent in substantially equimolar amounts (molar ratio of 90:100 to 110:100) and stirring the mixture.

In preparation of the polyamideimide, a dicarboxylic acid or a derivative thereof (dicarboxylic acid dichloride, dicarboxylic acid anhydride, or the like) may be used as a monomer in addition to the diamine and the tetracarboxylic dianhydride. In this case, the amount of each monomer can be adjusted such that the total amount of the tetracarboxylic dianhydride and the dicarboxylic acid or a derivative thereof is substantially equimolar amount to the amount of the diamine.

As described above, the polyimide-based resin exhibits transparency, solubility in an organic solvent, and compatibility with another resin, by adjusting its composition, i.e., the type and proportion of the acid dianhydride and the diamine.

The concentration of the polyamic acid solution may be 5 to 35 wt %, or 10 to 30 wt %. When the concentration is within this range, the polyamic acid obtained through polymerization has an appropriate molecular weight, and the polyamic acid solution has an appropriate viscosity.

In the polymerization of the polyamic acid, a method may be preferable in which the acid dianhydride is added to the diamine for suppressing ring opening of the acid dianhydride. When a plurality types of diamine and a plurality types of acid dianhydride are added, they may be added at one time, or may be added in a plurality of additions. Various physical properties of the polyimide-based resin can also be controlled by adjusting the order of addition of monomers.

The organic solvent used for polymerization of the polyamic acid is not particularly limited as long as it does not react with the diamine or the acid dianhydride but can dissolve the polyamic acid. Examples of the organic solvent include urea-based solvents such as methylurea and N,N-dimethylethylurea; sulfoxide or sulfone-based solvents such as dimethyl sulfoxide, diphenylsulfone and tetramethylsulfone; amide-based solvents such as N,N-dimethyacetamide (DMAc), N,N-dimethylformamide (DMF), N,N′-diethylacetamide, N-methyl-2-pyrrolidone (NMP), γ-butyrolactone, and hexamethylphosphoric triamide; alkyl halide-based solvents such as chloroform and methylene chloride; aromatic hydrocarbon-based solvents such as benzene and toluene; and ether-based solvents such as tetrahydrofuran, 1,3-dioxolane, 1,4-dioxane, dimethyl ether, diethyl ether, and p-cresol methyl ether. These solvents are typically used singly, or as necessary, two or more thereof are used in combination as appropriate. From the viewpoint of the solubility and polymerization reactivity of the polyamic acid, DMAc, DMF, NMP and the like may be used.

A polyimide-based resin can be obtained through cyclodehydration of the polyamic acid. Examples of the method for preparing the polyimide-based resin from a polyamic acid solution include a method in which a dehydrating agent, an imidization catalyst and the like are added to a polyamic acid solution to advance imidization in the solution. The polyamic acid solution may be heated to accelerate the progress of imidization. By mixing a poor solvent with a solution containing the polyimide-based resin generated through imidization of the polyamic acid, a polyimide-based resin is precipitated as a solid. By isolating the polyimide-based resin as a solid substance, impurities generated during synthesis of the polyamic acid, and the residual dehydration agent and the imidization catalyst and the like can be washed and removed with the poor solvent, and thus, it is possible to prevent coloring of the polyimide-based resin and an increase in yellowness index. By isolating the polyimide-based resin as a solid, a solvent suitable for forming a film, such as a low-boiling-point solvent, can be applied in preparation of a solution for producing a film.

The molecular weight (weight-average molecular weight in terms of polyethylene oxide which is measured by gel permeation chromatography (GPC)) of the polyimide-based resin may be 10,000 to 300,000, 20,000 to 250,000, or 40,000 to 200,000. An excessively small molecular weight may result in insufficient strength of the film. An excessively large molecular weight may result in poor compatibility with another resin.

The polyimide-based resin may be soluble in a low-boiling-point solvent such as a ketone-based solvent or a halogenated alkyl-based solvent. The phrase “the polyimide-based resin exhibits solubility in a solvent” means that the polyimide-based resin is dissolved at a concentration of 5 wt % or more. In an embodiment, the polyimide-based resin exhibits solubility in methylene chloride. Methylene chloride has a low boiling point, and thus it is easy to remove the residual solvent at the time of producing a film. Thus, the use of a polyimide-based resin soluble in methylene chloride can be expected to improve productivity of the film.

From the viewpoint of thermal stability and light stability of the transparent film, the polyimide-based resin may have low reactivity. The acid value of the polyimide-based resin may be 0.4 mmol/g or less, 0.3 mmol/g or less, or 0.2 mmol/g or less. The acid value of the polyimide may be 0.1 mmol/g or less, 0.05 mmol/g or less, or 0.03 mmol/g or less. From the viewpoint of reducing the acid value, the polyimide-based resin may have a high imidization ratio. A small acid value tends to lead to enhancement of the stability of the polyimide-based resin and improvement in compatibility with another resin.

### <Another Resin>

As described above, in addition to the polyimide-based resin, the transparent film may contain a resin other than the polyimide-based resin. The resin other than the polyimide-based resin (“another resin”) is not particularly limited as long as it can be mixed with the polyimide-based resin to form a transparent film, and examples thereof include those capable of being compatible with the polyimide-based resin and those forming a microphase separation structure such as a sea-island structure, a cylinder structure, or a lamellar structure. Of these, another resin may be compatible with the polyimide-based resin. When the polyimide-based resin and another resin are compatible with each other, there is a tendency that transparency is high, and mechanical properties such as elastic modulus and pencil hardness are excellent regardless of processing conditions of the film.

Examples of the resin exhibiting compatibility with the polyimide-based resin include an acryl-based resin, a polycarbonate-based resin, a polyester-based resin, a polyamide-based resin, a polyether-based resin, a cellulose-based resin, a silicone-based resin, and a cyclic olefin-based resin. A plurality of types of these resins may be used.

From the viewpoint of high compatibility with the polyimide-based resin, non-limiting examples of another resin may include an acryl-based resin, a polycarbonate-based resin, and a polyester-based resin having a fluorene structure. Of these, an acryl-based resin may be preferable because it exhibits high compatibility with the polyimide-based resin, has a low refractive index, and easily forms a film having high hardness.

Examples of the acryl-based resin include poly(meth)acrylic acid esters such as polymethyl methacrylate, methyl methacrylate-(meth)acrylic acid copolymers, methyl methacrylate-(meth)acrylic acid ester copolymers, methyl methacrylate-acrylic acid ester-(meth)acrylic acid copolymers, and methyl (meth)acrylate-styrene copolymers. The acryl-based resin may have a glutarimide structural unit or a lactone ring structural unit introduced through modification.

From the viewpoint of transparency, compatibility with the polyimide-based resin, and mechanical strength, the acryl-based resin may have methyl methacrylate as a main structural unit. The amount of methyl methacrylate with respect to the amount of all monomer components in the acryl-based resin may be 60 wt % or more, 70 wt % or more, 80 wt % or more, 85 wt % or more, 90 wt % or more, or 95 wt % or more. The acryl-based resin may be a homopolymer of methyl methacrylate. The acryl-based resin may be obtained by introducing a glutarimide structure or a lactone ring structure into an acryl-based polymer having a methyl methacrylate content in the above range.

From the viewpoint of the heat-resistance of the transparent film, the glass transition temperature of the acryl-based resin may be 100° C. or higher, 110° C. or higher, 115° C. or higher, or 120° C. or higher.

From the viewpoint of solubility in an organic solvent, compatibility with the polyimide-based resin, and film strength, the weight-average molecular weight of the acryl-based resin (in terms of polystyrene) may be 5,000 to 500,000, 10,000 to 300,000, or 15,000 to 200,000.

From the viewpoint of the heat stability and light stability of the film, it may be preferable that the content of reactive functional groups such as ethylenically unsaturated groups and carboxy groups in the acryl-based resin is small. The iodine value of the acryl-based resin may be 10.16 g/100 g (0.4 mmol/g) or less, 7.62 g/100 g (0.3 mmol/g) or less, or 5.08 g/100 g (0.2 mmol/g) or less. The iodine value of the acryl-based resin may be 2.54 g/100 g (0.1 mmol/g) or less, or 1.27 g/100 g (0.05 mmol/g) or less. The acid value of the acryl-based resin may be 0.4 mmol/g or less, 0.3 mmol/g or less, or 0.2 mmol/g or less. The acid value of the acryl-based resin may be 0.1 mmol/g or less, 0.05 mmol/g or less, or 0.03 mmol/g or less. A small acid value tends to lead to enhancement of the stability of the acryl-based resin and improvement of compatibility with the polyimide-based resin.

### <Bluing Agent>

The transparent film contains a bluing agent in addition to the resin component described above. The bluing agent is a coloring matter (dye or pigment) that absorbs light in a long wavelength range of visible light (light such as red, orange, and yellow) and adjusts a color tone.

Examples of the bluing agent include organic pigments such as phthalocyanine blue; inorganic pigments such as ultramarine blue, Prussian blue, and cobalt blue; organic dyes such as anthraquinone-based compounds having an anthraquinone ring structure, indigo compounds, and methine compounds. From the viewpoint of solubility and dispersibility in a resin or a solvent, an organic dye may be preferable. From the viewpoint of heat-resistance and light-resistance, an anthraquinone-based compound may be preferable. Pigments may be preferable from the viewpoint of light-resistance and heat-resistance, and phthalocyanine blue or ultramarine blue may be preferable from the viewpoint of dispersibility in the resin. Since a pigment-based bluing agent itself has high light-resistance, an increase in yellowness index caused by deterioration of the bluing agent can be suppressed. On the other hand, since a dye-based bluing agent is excellent in solubility, an increase in haze due to the addition of the bluing agent can be suppressed, which is advantageous from the viewpoint of transparency. Only one bluing agent may be used, or two or more thereof may be used in combination.

Examples of commercially available products of the anthraquinone-based bluing agent include “Plast Blue” manufactured by Arimoto Chemical Co., Ltd. Examples of commercially available products of the phthalocyanine-based bluing agent include “ET4B403” manufactured by Dainichiseika Color & Chemicals Mfg. Co., Ltd., and “BL-G20” manufactured by Sanyo Color Works, LTD. Examples of commercially available products of ultramarine bluing agents include “Ultramarine Blue 51” manufactured by Holliday Pigments.

The bluing agent may have high heat-resistance. The 1% weight loss temperature of the bluing agent may be 200° C. or higher, 220° C. or higher, or 240° C. or higher.

Since the polyimide absorbs light in a short wavelength range of visible light, a film containing a polyimide-based resin is slightly colored in yellow, and typically has a yellowness index (YI) of more than 0. When the transparent film contains the bluing agent, light absorption in a long wavelength range of visible light increases. Thus, YI of transmitted light and reflected light is reduced, and the hue is neutralized.

### <Ultraviolet Absorber>

The transparent film may contain an ultraviolet absorber. The inclusion of an ultraviolet absorber tends to improve light-resistance and suppress deterioration of the resin due to ultraviolet rays. Examples of the ultraviolet absorber include a triazine-based ultraviolet absorber, a benzotriazole-based ultraviolet absorber, a benzophenone-based ultraviolet absorber, a cyanoacrylate-based ultraviolet absorber, and a hydroxybenzoate-based ultraviolet absorber. Of these, a triazine-based ultraviolet absorber or a benzotriazole-based ultraviolet absorber may be preferable because good light-resistance can be obtained. Only one ultraviolet absorber may be used, or two or more thereof may be used in combination.

### <Composition of Transparent Film>

As described above, the transparent film contains, as a resin component, a polyimide-based resin, and may further contain another resin. The ratio of the polyimide-based resin to another resin in the transparent film is not particularly limited. The mixing ratio (weight ratio) of the polyimide-based resin and another resin may be 98:2 to 2:98, 95:5 to 10:90, 90:10 to 15:85, or 65:35 to 50:50. When the ratio of the polyimide-based resin is high, the elastic modulus and the pencil hardness of the film tends to increase, resulting in excellent mechanical strength. A higher ratio of another resin tends to lead less coloring of the film, higher total light transmittance, lower yellowness index (YI), and higher transparency.

To sufficiently exhibit the effect of improving the transparency by mixing the polyimide-based resin and another resin, the ratio of another resin may be 10 to 90 wt %, 15 to 85 wt %, 20 to 80 wt %, 30 to 70 wt %, 35 to 65 wt %, or 40 to 60 wt %.

As described above, when the film contains the bluing agent, the hue is neutralized, but because the bluing agent absorbs light in a long wavelength range of visible light, the total light transmittance tends to decrease as the amount of the bluing agent increases. A mixed resin film of a polyimide-based resin and another resin is less colored (has a smaller YI) than a film of a polyimide-based resin alone. Thus, the amount of the bluing agent required to neutralize the hue (bring YI close to 0) is small, the decrease in the total light transmittance can be suppressed, and the visibility of the display can be improved.

The content (concentration) of the bluing agent in the transparent film may be adjusted such that the yellowness index (YI) of the film becomes a value close to 0 in consideration of the type (light absorption coefficient) of the bluing agent. The content of the bluing agent may be 10 ppm or more, 20 ppm or more, 30 ppm or more, 40 ppm or more, or 50 ppm or more. When the bluing agent is a pigment, the content of the bluing agent may be 100 ppm or more, 150 ppm or more, or 200 ppm or more.

When the amount of the bluing agent is excessively large, the total light transmittance decreases, and YI excessively decreases. Thus, transmitted light and reflected light may be colored in blue and visually recognized. Thus, the content of the bluing agent in the transparent film may be 2000 ppm or less, 1000 ppm or less, 800 ppm or less, 600 ppm or less, or 500 ppm or less. When the bluing agent is an organic dye such as an anthraquinone-based compound, the content of the bluing agent may be 200 ppm or less, 100 ppm or less, 80 ppm or less or 60 ppm or less.

The content of the ultraviolet absorber in the transparent film may be 0.1 parts by weight or more, 1 part by weight or more, 3 parts by weight or more, 4 parts by weight or more or 5 parts by weight or more with respect to 100 parts by weight of the total of the resin components. As the content of the ultraviolet absorber increases, the light-resistance of the film tends to improve. On the other hand, YI tends to increase as the content of the ultraviolet absorber increases. From the viewpoint of suppressing coloring, the content of the ultraviolet absorber may be 10 parts by weight or less, 8 parts by weight or less, 7 parts by weight or less, or 6 parts by weight or less.

In addition to the resin component, the bluing agent, and the ultraviolet absorber, the transparent film may contain an organic or inorganic low molecular weight compound or the like. The transparent film may contain, as an additive, a flame retardant, a stabilizer, a crosslinking agent, a surfactant, a leveling agent, a plasticizer, fine particles, or the like.

The transparent film may contain organic fine particles such as polystyrene and a crosslinked acryl-based resin, and inorganic fine particles such as silica and a layered silicate for the purpose of improving blocking resistance, adjusting a refractive index, and the like. However, blending fine particles may cause a decrease in transmittance and an increase in haze of the film. In particular, silicon oxide such as silica is useful for reducing the refractive index of the film, but is likely to cause poor dispersion in the resin matrix, and is likely to cause deterioration in transparency, mechanical strength, and bending resistance. Thus, the content of the silicon oxide may be 5 parts by weight or less, 1 part by weight or less, 0.5 parts by weight or less, 0.1 parts by weight or less or 0 with respect to 100 parts by weight of the total of the resin components.

### <Production of Transparent Film>

The method for forming the transparent film is not particularly limited, and may be either a melting method or a solution method. A solution method may be preferable from the viewpoint of producing a film excellent in transparency and uniformity. In the solution method, a solution containing the resin component, the bluing agent, and the ultraviolet absorber is applied onto a support, and the solvent is removed by drying to obtain a film.

The solvent is not particularly limited as long as both the polyimide-based resin and another resin exhibit solubility in the solvent. Examples of the solvent include amide-based solvents such as N,N-dimethylformamide, N,N-dimethylacetamide and N-methyl-2-pyrrolidone; ether-based solvents such as tetrahydrofuran and 1,4-dioxane; ketone-based solvents such as acetone, methyl ethyl ketone, methyl propyl ketone, methyl isopropyl ketone, methyl isobutyl ketone, diethyl ketone, cyclopentanone, cyclohexanone, and methyl cyclohexanone; and halogenated alkyl solvents such as chloroform, 1,2-dichloroethane, 1,1,2,2-tetrachloroethane, chlorobenzene, dichlorobenzene, and methylene chloride. Of these, a ketone-based solvent and an alkyl halide-based solvent may be preferable because the polyimide resin or the like has excellent solubility in the solvents, the solvents have a low boiling point, and the residual of the solvents at the time of film production can be easily removed.

As a method for applying the resin solution onto a support, a known method using a bar coater, a comma coater or the like can be applied. As the support, a glass substrate, a metal substrate such as SUS, a metal drum, a metal belt, a plastic film, or the like can be used.

Heating may be performed when the solvent is dried. The heating temperature is not particularly limited as long as the solvent can be removed, and coloring of the resulting film can be suppressed, and the temperature is appropriately set to room temperature to about 250° C., and may be 50° C. to 220° C. The heating temperature may be elevated stepwise. To enhance the solvent removal efficiency, the resin film may be peeled off from the support and dried after the drying proceeds to some extent. Drying can be performed in an air atmosphere or a nitrogen atmosphere. To promote the removal of the solvent, heating may be performed under reduced pressure.

In a film obtained by applying a solution containing an ultraviolet absorber in addition to a resin and a solvent on a support and drying and removing the solvent, the ultraviolet absorber tends to be unevenly distributed on the surface in contact with the support at the time of application and drying (support surface). When the transparent film has a distribution of the content (concentration) of the ultraviolet absorber in a thickness direction, and ultraviolet rays are applied from the surface on the side where the concentration of the ultraviolet absorber is relatively high, a larger amount of ultraviolet rays is absorbed in the vicinity of the irradiated surface. Thus, the amount of ultraviolet rays reaching the inside of the film in the thickness direction and the surface on the opposite side of the irradiated surface is small, leading to suppression of the deterioration of the resin caused by the ultraviolet ray. Thus, when the transparent film has a concentration distribution of the ultraviolet absorber in the thickness direction, the light-resistance to be exhibited when the transparent film is irradiated with ultraviolet rays from the surface on the side where the concentration of the ultraviolet absorber is relatively high (surface on the support side at the time of application and drying) tends to be better (ΔYI to be described later is smaller) than the light-resistance to be exhibited when the transparent film is irradiated with ultraviolet rays from the surface on the side where the concentration of the ultraviolet absorber is relatively low (air surface at the time of application and drying).

For the purpose of, for example, improving the mechanical strength of the film, the film may be stretched in one direction or a plurality of directions. When the film is stretched, polymer chains are oriented in a stretching direction, and thus, the strength in an in-plane direction of the film is improved, and the occurrence of breaking and cracking of the film tends to be suppressed.

A film of an acryl-based resin, which is an example of another resin (resin other than the polyimide-based resin), may have low toughness, but the strength of the film may be improved by employing a compatible system of the polyimide-based resin and the acryl-based resin. In addition, when a film made of the compatible system of the polyimide-based resin and the acryl-based resin is stretched, the tensile modulus in the stretching direction tends to increase, and accordingly, the bending resistance tends to improve.

For example, a film used as a cover window of a foldable display device (foldable display) or a substrate material is repeatedly bent along a bending axis at the same position. Such a film is required to have high mechanical strength in a direction perpendicular to the bending axis. Thus, by disposing the film such that the stretching direction of the film is perpendicular to the bending axis, the film is hardly broken or cracked at the bent portion even though bending is repeated, and a device having high bending resistance can be provided.

Stretching conditions of the film are not particularly limited. For example, the stretching temperature is about +40° C. of the glass transition temperature of the film, and the temperature may be about 120 to 300° C., 150 to 250° C., or 180 to 230° C. The stretching ratio is about 1 to 200%, and it may be 5 to 150%, 10 to 120%, or 20 to 100%. The tensile modulus in the stretching direction tends to increase as the stretching ratio increases. On the other hand, when the stretching ratio is excessively large, the mechanical strength in the direction perpendicular to the stretching direction tends to decrease, and the handleability of the film may decrease.

From the viewpoint of enhancing the strength in all directions in the film plane, the film may be biaxially stretched. The biaxial stretching may be simultaneous biaxial stretching or sequential biaxial stretching. In the biaxial stretching, the stretching ratio in one direction and the stretching ratio in a direction perpendicular to the one direction may be the same or different. When the stretching ratios in one direction and another direction are different, the mechanical strength in a direction in which the stretching ratio is large tends to be relatively large. When a biaxially stretched film having an anisotropic stretching ratio is used for a foldable device, it may be preferable to dispose the biaxially stretched film such that a direction in which the stretching ratio is large is perpendicular to the bending axis.

The thickness of the transparent film is not limited, and may appropriately be set according to the intended use of the transparent film. The thickness of the transparent film is, for example, 5 to 300 μm. The thickness of the transparent film may be 20 to 100 μm, 25 to 80 μm, 30 to 70 μm, or 35 to 65 μm from the viewpoint of achieving both self-support and flexibility and providing a highly transparent film. The thickness of the film used for a cover window of a display may be 20 μm or more. When the film is stretched, the thickness after stretching may be within the above range.

### <Characteristics of Transparent Film>

The transparent film may have a single glass transition temperature in differential scanning calorimetry (DSC) and/or dynamic mechanical analysis (DMA). When the polyimide-based resin contained in the transparent film is compatible with another resin, the transparent film has a single glass transition temperature.

The haze of the transparent film may be 10% or less, 5% or less, 4% or less, 3.5% or less, 3% or less, 2% or less, 1% or less, or 0.5% or less. When the transparent film contains a polyimide-based resin and another resin, low haze can be achieved by using a resin having high compatibility with the polyimide-based resin such as an acryl-based resin as another resin. The polyimide-based resin and another resin are not necessarily completely compatible with each other, and may have a small microphase separation structure to such an extent that optical characteristics are not affected. By using a bluing agent having high compatibility and dispersibility with the resin matrix, an increase in haze can be suppressed.

As described above, the transparent film has a total light transmittance of 90.0% or more. The total light transmittance of the transparent film may be 90.3% or more, 90.5% or more, 91.0% or more or 91.5% or more. As the total light transmittance is higher, the white luminance of the display tends to be higher, and the visibility tends to be excellent.

The yellowness index (YI) of the transparent film may be-1.0 or more and 1.0 or less, −0.6 to 0.8, or −0.5 to 0.5. The smaller the YI, the less the yellowish coloring, and the better the visibility.

The total light transmittance (TT: %) and yellowness index (YI) of the transparent film may satisfy the following relationship.

$$YI < 1.44 \times TT - 130$$

Although the polyimide-based resin film is slightly colored in yellow, by adopting a mixed-resin with an acryl-based resin or the like, light absorption of the polyimide-based resin is reduced, and thus coloring can be reduced, and the total light transmittance can be increased. In general, a polyimide-based resin has a high refractive index, and has a high reflectance at an interface with air and an interface with other layers. By adopting a mixed resin, the refractive index is lowered, the reflectance is reduced, and thus, the total light transmittance increases.

A film of a mixed resin of the polyimide-based resin and another resin has YI smaller than that of a film of the polyimide-based resin alone, but is still slightly colored in yellow. YI may be generally more than 0, and YI may be more than 1.0. When the transparent film contains a bluing agent, the YI can be reduced. Since YI of the film of the mixed resin is lower than YI of the film of the polyimide-based resin alone, YI can be brought close to 0 (adjusted to 1.0 or less) with a small amount of a bluing agent, and a decrease in total light transmittance due to light absorption of the bluing agent can be suppressed.

Since the mixed resin of the polyimide-based resin and another resin has higher light-resistance than the case of using the polyimide-based resin alone, the amount of the ultraviolet absorber can be reduced. The smaller the content of the ultraviolet absorber, the smaller the light absorption in a short wavelength range of visible light, and YI of the transparent film tends to decrease.

The transparent film may have ΔYI₁, which is an increase amount of YI in a carbon arc light-resistance test, of 5.0 or less. In the carbon arc light-resistance test, the transparent film is irradiated with ultraviolet rays for 48 hours under conditions of an irradiation intensity of 500 W/m² and a black panel temperature of 63° C. using a carbon arc light source. . . . ΔYI₁ of the transparent film may be 4.0 or less, 2.0 or less, or 1.0 or less.

The increase in YI due to ultraviolet irradiation is mainly caused by photodegradation of the polyimide-based resin. Thus, in the mixed resin of the polyimide-based resin and another resin, as the proportion of the polyimide-based resin is smaller, YI tends to be smaller and excellent in transparency, and ΔYI tends to be smaller and excellent in light-resistance. When the transparent film contains an ultraviolet absorber, the amount of ultraviolet rays absorbed by the polyimide-based resin is reduced, and ΔYI tends to decrease because the ultraviolet absorber absorbs ultraviolet rays.

As described above, as the content of the ultraviolet absorber contained in the transparent film increases, the light-resistance tends to improve, and ΔYI tends to decrease, but as the content of the ultraviolet absorber increases, YI (yellowness index YI₀ before ultraviolet irradiation) of the transparent film tends to increase. When the transparent film has a concentration distribution of the ultraviolet absorber in the thickness direction, the amount of increase in YI in the case where the transparent film is irradiated with ultraviolet rays from the surface on the side where the concentration of the ultraviolet absorber is relatively high tends to be smaller than the amount of increase in YI in the case where the transparent film is irradiated with ultraviolet rays from the surface on the side where the concentration of the ultraviolet absorber is relatively low.

Depending on the use conditions, the transparent film may be required to have higher light-resistance. In such applications requiring high light-resistance, the transparent film may have ΔYI₂, which is an increase amount of YI in a xenon light-resistance test, of 5.0 or less. In the carbon arc light-resistance test, the transparent film is irradiated with ultraviolet rays for 200 hours under conditions of an irradiation intensity of ultraviolet rays having a wavelength of 300 nm to 400 nm of 180 W/m² and a black panel temperature of 80° C. using a xenon light source. ΔYI₂ of the transparent film may be 3.0 or less, 2.0 or less, or 1.5 or less. In general, the value of ΔYI₂, which is an amount of increase in YI by the xenon light-resistance test for 200 hours, is larger than the value of ΔYI₁, which is an amount of increase in YI by the carbon arc light-resistance test for 48 hours.

In the xenon light-resistance test, in addition to photodegradation of the resin component of the transparent film, photodegradation of the bluing agent may also cause an increase in yellowness index. To reduce ΔYI₂, it may be preferable to use a bluing agent that hardly causes deterioration due to light irradiation. A blue pigment such as phthalocyanine or ultramarine blue hardly causes photodegradation, and is useful for improving light-resistance of a transparent film containing a bluing agent.

The photodegradation of the bluing agent can be evaluated with a change amount of the light transmittance (%) at a maximum wavelength λₘₐₓ of the bluing agent before and after the xenon light-resistance test: ΔT₂=(light transmittance T₂ after light-resistance test)-(light transmittance To before light-resistance test). The smaller ΔT₂ is, the smaller the photodegradation of the bluing agent is, and the better the light-resistance is. ΔT₂ may be 1.0% or less, 0.5 or less, less than 0.4%, 0.3% or less or 0.2% or less.

The refractive index of the transparent film may be 1.60 or less. The refractive index of the transparent film may be 1.58 or less, 1.56 or less, 1.54 or less, or 1.52 or less. The refractive index of a film containing only a polyimide-based resin as the resin component is typically higher than 1.60, and light reflection due to a difference in refractive index from an air interface or an interface with another member is large (reflectance is high), and thus light transmittance is small. Since the mixed resin of the polyimide-based resin and another resin has a lower refractive index than the case of the polyimide-based resin alone, light reflection at the interface is reduced, and the total light transmittance is increased. In particular, since an acryl-based resin has a low refractive index, when an acryl-based resin is used as another resin, the transparent film tends to have a low refractive index and a high total light transmittance. By adopting the mixed resin of a polyimide-based resin and a low refractive index resin such as an acryl-based resin, the refractive index of the transparent film can be adjusted to 1.60 or less, and the total light transmittance can be increased without using low refractive particles such as silica (or at a low content).

Since a stretched film tends to have a large refractive index in the stretching direction (orientation direction of polymer chains), the film may have in-plane refractive index anisotropy when the transparent film is a stretched film. The transparent film may have an in-plane refractive index difference (a difference between the maximum refractive index and the minimum refractive index in the plane) of 0.01 or more, 0.02 or more, 0.03 or more, or 0.04 or more. When the transparent film has refractive index anisotropy, the maximum in-plane refractive index (generally, the refractive index in the stretching direction) may be in the above range.

The tensile modulus of the transparent film may be 3.0 GPa or more, 3.5 GPa or more, 4.5 GPa or more, 5.0 GPa or more, 5.5 GPa or more, or 6.0 GPa or more. The larger the tensile modulus is, the better the mechanical strength tends to be. The transparent film may have in-plane anisotropy in tensile modulus. When the transparent film is a stretched film, the tensile modulus in the stretching direction tends to be larger than the tensile modulus in a direction perpendicular to the stretching direction. When the transparent film is a biaxially stretched film or a fixed-end uniaxially stretched film, the tensile modulus in all directions in the plane may be larger than that before stretching. When the transparent film has in-plane anisotropy of tensile modulus, the maximum in-plane tensile modulus (generally, tensile modulus in the stretching direction) may be in the above range.

### [Laminate]

The transparent film may be provided as a laminate including various functional layers on one or both principal surfaces. Examples of the functional layer include a hard coat layer, an ultraviolet absorbing layer, an adhesive layer, a refractive index adjusting layer, and an easily bonding layer.

Examples of an application form of the transparent film include a hard coat film including a hard coat layer containing a cured product of a curable resin on a principal surface of the transparent film. By providing the hard coat layer on the principal surface of the transparent film, scratch resistance and hardness can be imparted.

The hard coat layer may be provided only on one surface of the transparent film, or may be provided on both surfaces of the transparent film. When the transparent film contains an ultraviolet absorber and has a concentration distribution of the ultraviolet absorber in the thickness direction, by providing the hard coat layer on the surface on the side where the concentration of the ultraviolet absorber is relatively high, photodegradation of the transparent film when the hard coat film is irradiated with ultraviolet rays from the hard coat layer side tends to be suppressed, and light-resistance tends to be improved.

The curable resin material constituting the hard coat layer is not particularly limited as long as it has a function of preventing generation of scratches, and examples thereof include polyester-based resins, acryl-based resins, urethane-based resins, amide-based resins, siloxane-based resins and epoxy-based resins. Of these, an acryl-based hard coat layer which is a cured product of an acryl-based hard coat resin composition or a siloxane-based hard coat layer which is a cured product of a siloxane-based hard coat resin composition may be from the viewpoint of preventing generation of scratches.

The acryl-based hard coat material contains a monomer or oligomer having a (meth)acryloyl group in the molecule as a curable resin component. The molecular weight of the acrylic monomer or oligomer is, for example, about 200 to 10,000. The acryl-based hard coat material can control hardness, scratch resistance, bending resistance, optical characteristics, and the like by combining a plurality of monomers or oligomers having a (meth)acryloyl group. From the viewpoint of curability through photoradical polymerization, the hard coat material may have an acryloyl group.

The siloxane-based hard coat material contains a curable compound having a siloxane bond as a curable resin component. From the viewpoint of resistance to scratches, the siloxane-based curable compound may have an epoxy group as a polymerizable functional group, and in particular, a polyorganosiloxane compound containing an alicyclic epoxy group may be preferable. Such siloxane-based hard coat materials are disclosed in WO 2014/204010 A, WO 2018/096729 A, WO 2020/040209 A, and the like, and these descriptions can be referred to and incorporated.

Since a siloxane-based hard coat material having an alicyclic epoxy group as a polymerizable functional group has small curing shrinkage during curing, curling and cracking are less likely to occur even when the thickness of the hard coat layer is increased.

The thickness of the hard coat layer may be, for example, 1 to 50 μm, 3 to 40 μm, 5 to 30 μm or 10 to 25 μm. As the thickness of the hard coat layer is larger, the pencil hardness tends to be higher, and the scratch resistance tends to be improved. On the other hand, when the thickness of the hard coat layer is excessively large, the bending resistance tends to decrease.

The pencil hardness of the hard coat layer-formed surface of the hard coat film may be 3H or more, 4H or more, 5H or more, or 6H or more. As the pencil hardness is higher, scratches and dents caused by external force are less likely to occur. The higher the pencil hardness is, the more excellent the scratch resistance is, and the film can be suitably used for applications such as a cover window disposed on the outermost surface of a display.

The transparent film of one or more embodiments of the present invention and the laminate including a functional layer such as a hard coat layer on the transparent film are high in total light transmittance and less colored. Thus, they can be used as a display material, and can be used as a cover window provided on the surface of an image display panel, a transparent substrate for a display, a transparent substrate for a touch panel, and the like. In particular, a hard coat film including a hard coat layer on the transparent film has excellent scratch resistance, and thus can be suitably used as a cover window material.

### EXAMPLES

Hereinafter, one or more embodiments of the present invention will be described more specifically based on Examples and Comparative Examples, but the present invention is not limited to the following Examples. Hereinafter, a casting direction at the time of application is referred to as MD, and a direction perpendicular to MD is referred to as TD.

### [Preparation of Polyimide Resin]

Dimethylformamide (DMF) was added into a separable flask and stirred in a nitrogen atmosphere. Diamine and tetracarboxylic dianhydride were added thereto at the proportions (mol %) shown in Table 1, and the mixture was stirred for 5 to 10 hours under a nitrogen atmosphere to react, whereby a polyamic acid solution having a solid content concentration of 18 wt % was obtained.

To 100 g of the polyamic acid solution, 5.5 g of pyridine as an imidization catalyst was added, and completely dispersed, 8 g of acetic anhydride was then added, and the mixture was stirred at 90° C. for 3 hours. The solution was cooled to room temperature, and 100 g of 2-propyl alcohol (IPA) was then added dropwise at a rate of 2 to 3 drops/see while the solution was stirred, whereby a polyimide was precipitated. Further, 150 g of IPA was added, the mixture was stirred for about 30 minutes, and suction filtration was performed with a Kiriyama funnel. The obtained solid was washed with IPA, and then dried in a vacuum oven set at 120° C. for 12 hours, whereby polyimide resins 1 and 2 (PI1, PI2) were obtained.

In Table 1, the compounds are abbreviated as follows.

### <Tetracarboxylic Dianhydride>

CBDA: 1,2,3,4-cyclobutanetetracarboxylic dianhydride

6FDA: 2,2-bis(3,4-dicarboxyphenyl)-1,1,1,3,3,3-hexafluoropropanoic dianhydride

TAHMBP: bis(1,3-dioxo-1,3-dihydroisobenzofuran-5-carboxylic acid)-2,2′,3,3′,5,5′-hexamethylbiphenyl-4,4′-diyl

ODPA: 4,4′-oxydiphthalic dianhydride

### <Diamine>

TFMB: 2,2′-bis(trifluoromethyl)benzidine

DDS: 3,3′-diaminodiphenylsulfone

TABLE 1

| | Acid dianhydride | | | | Diamine | |
|---|---|---|---|---|---|---|
| | CBDA | 6FDA | TAHMBP | ODPA | TFMB | DDS |
| PI 1 | 30 | 70 | — | — | 100 | — |
| PI 2 | 30 | — | 50 | 20 | 90 | 10 |

[Production of Transparent Film]

### EXAMPLE 1

A solution having a solid content concentration of 11 wt % was prepared by dissolving the polyimide resin 1 (PI1) and a commercially available acryl-based resin (“PARAPET G” manufactured by KURARAY CO., LTD.; methyl methacrylate/methyl acrylate (monomer ratio: 87/13) copolymer, glass transition temperature: 109° C., acid value: 0.0 mmol/g; hereinafter, described as “acryl-based resin”) in methylene chloride at a weight ratio of 55:45, 5.6 parts by weight of a benzotriazole-based ultraviolet absorber (“ADK STAB LA-31RG” manufactured by ADEKA CORPORATION) and 0.002 parts by weight of an anthraquinone-based bluing agent (“Plast Blue 8590” manufactured by Arimoto Chemical Co., Ltd.) were added to 100 parts by weight of the total solid content of the resin, and the mixture was stirred.

This solution was applied onto an alkali-free glass plate, and dried by heating at 60° C. for 15 minutes, at 90° C. for 15 minutes, at 120° C. for 15 minutes, at 150° C. for 15 minutes, and at 180° C. for 15 minutes in an air atmosphere. Thereafter, the film was peeled off from the alkali-free glass plate, whereby a film 1 having a thickness of 50 μm was obtained. Hereinafter, the surface in contact with the alkali-free glass plate at the time of applying and drying the film may be referred to as “support surface”.

### <Comparative Examples 1 and 3>

In preparation of the solution, no bluing agent or ultraviolet absorber was blended in Comparative Example 1, and no bluing agent was blended in Comparative Example 3. Except for these changes, a film having a thickness of 50 μm was obtained in the same manner as in Example 1.

### EXAMPLE 2

A film having a thickness of 110 μm was obtained in the same manner as in Example 1 except that the coating thickness was changed. The obtained film was subjected to fixed-end uniaxial stretching using a stretching machine equipped with a heating oven at a temperature of 215° C. and at a stretching ratio of 120% along the MD as the stretching direction (MD length was 2.20 times that of the film before stretching), whereby a stretched film having a thickness of 50 μm was obtained.

### <Examples 3 to 6, Comparative Examples 2 and 4>

A stretched film having a thickness of 50 μm was obtained in the same manner as in Example 2 except that the type and the amount of the ultraviolet absorber were changed as shown in Table 2. In Example 4, a triazine-based ultraviolet absorber (“Tinuvin 477” manufactured by BASF) was used.

### Comparative Example 5

The polyimide resin 2 (PI2) was dissolved in methylene chloride to prepare a solution having a solid content concentration of 10 wt %, 2.0 parts by weight of a triazine-based ultraviolet absorber was added with respect to 100 parts by weight of the solid content of the resin, and the mixture was stirred. This solution was applied onto an alkali-free glass plate, and heated and dried at 40° C. for 60 minutes, 80° C. for 30 minutes, 150° C. for 30 minutes, 170° C. for 30 minutes, and 200° C. for 60 minutes in an air atmosphere, whereby a film 3 having a thickness of 50 μm was obtained.

### [Evaluation of Transparent Film]

The refractive index, tensile modulus, total light transmittance, yellowness index (YI), and light-resistance obtained through a carbon arc test of the transparent films of Examples 1 to 6 and Comparative Examples 1 to 5 were evaluated by the following methods.

### <Refractive Index>

Each film was cut into a 3 cm square, the orientation angle was measured using a retardation measuring apparatus (“OPTIPRO 21-255MA” manufactured by SHINTECH Co., Ltd.), and the direction in which the refractive index was maximized was determined. Each of the stretched films had the maximum refractive index in the stretching direction (MD). The refractive index in the direction in which the refractive index was maximum (MD) and the refractive index in the direction perpendicular thereto (TD) were measured with a prism coupler (“2010/M” manufactured by Metricon Corporation). The refractive index at a wavelength of 589 nm obtained by performing Cauchy dispersion fitting on the measured values at wavelengths of 404 nm, 594 nm, and 827 nm was taken as the refractive index of the film.

### <Tensile Modulus>

Each film was cut into a strip shape having a width of 10 mm, and allowed to stand at 23° C./55% RH for 1 day to adjust the humidity, and then a tensile test was performed under the following conditions using a tensile tester “AUTOGRAPH AGS-X” manufactured by Shimadzu Corporation to calculate a tensile modulus.
Distance between chucks: 100 mm
Tensile speed: 12.5 mm/min
Measurement temperature: 23° C.

The tensile test was performed in each of MD and TD, and the higher value was taken as the tensile modulus of the film. Each of the stretched films had a tensile modulus higher in the stretching direction (MD) than in the direction perpendicular thereto (TD).

### <Total Light Transmittance and Haze>

The total light transmittance and the haze were measured by the methods described in JIS K7361-1:1999 and JIS K7136:2000 using a haze meter HZ-V3 manufactured by Suga Test Instruments Co., Ltd. A D65 light source was used for the measurement.

### <Yellowness Index (YI)>

The yellowness index was measured according to JIS K7373 using a spectrophotometer SC-P manufactured by Suga Test Instruments Co., Ltd.

### <Carbon Arc Light-Resistance Test>

Using a fade meter (“U48HB” manufactured by Suga Test Instruments Co., Ltd.), the film was irradiated with ultraviolet rays from the support surface side for 48 hours under the conditions of ultraviolet rays: carbon arc lamp, irradiance: 500 W/m², black panel temperature: 63° C., and no rain. For the film of Example 2, in addition to irradiation from the support surface, a test of irradiating the film with ultraviolet rays from the surface opposite to the support surface (air surface at the time of application and drying) was also performed. The yellowness index YI₁ was measured after ultraviolet irradiation, and the difference ΔYI₁=YI₁-YI₀ from the yellowness index YI₀ before ultraviolet irradiation was calculated.

The compositions and evaluation results of the films of Examples 1 to 6 and Comparative Examples 1 to 5 are shown in Table 2. The numerical values of the compositions in Table 2 are weight ratios (parts by weight) where the total of the resin components is 100.

TABLE 2

| | | | Example 1 | Example 2 | Example 3 | Example 4 | Example 5 | Example 6 |
|---|---|---|---|---|---|---|---|---|
| Composition | PI 1 | | 55 | | | | | |
| | PI 2 | | — | | | | | |
| | Acryl | | 45 | | | | | |
| | Bluing | Plast | 0.002 | 0.002 | 0.002 | 0.002 | 0.004 | 0.006 |
| | agent | Blue | | | | | | |
| | | 8590 | | | | | | |
| | Ultraviolet | LA- | 5.6 | 5.6 | 1.8 | — | 5.6 | 5.6 |
| | absorber | 31RG | | | | | | |
| | | Tinuvin | — | — | — | 3.2 | — | — |
| | | 477 | | | | | | |

| Stretching | | None | Stretched | Stretched | Stretched | Stretched | Stretched |
|---|---|---|---|---|---|---|---|
| Refractive index | MD | 1.53 | 1.52 | 1.52 | 1.52 | 1.52 | 1.52 |
| | TD | 1.53 | 1.56 | 1.56 | 1.56 | 1.56 | 1.56 |

| Tensile modulus (Gpa) | 3.9 | 5.7 | | 5.7 | 5.7 | 5.7 | 5.7 |
|---|---|---|---|---|---|---|---|
| Total light | 91.1 | 91.0 | | 91.1 | 91.1 | 90.6 | 90.2 |
| transmittance (%) | | | | | | | |
| YI | 0.9 | 0.9 | | 0.4 | 1.0 | 0.3 | −0.3 |
| ΔYI₁ | 0.8 | 0.8 | 1.3 | 1.7 | 1.8 | 0.9 | 1.0 |

| | |
|---|---|
| (Support | (Air |
| surface) | surface) |

| | | | | |
|---|---|---|---|---|
| Comparative | Comparative | Comparative | Comparative | Comparative |
| Example 1 | Example 2 | Example 3 | Example 4 | Example 5 |

| | | | |
|---|---|---|---|
| Composition | PI 1 | 55 | — |
| | PI 2 | — | 100 |
| | Acryl | 45 | — |

| | | | | | | |
|---|---|---|---|---|---|---|
| Bluing | Plast | — | — | — | 0.008 | 0.0062 |
| agent | Blue | | | | | |
| | 8590 | | | | | |
| Ultraviolet | LA- | — | 5.6 | 5.6 | 5.6 | — |
| absorber | 31RG | | | | | |
| | Tinuvin | | — | — | — | 2.4 |
| | 477 | | | | | |

| Stretching | | None | Stretched | None | Stretched | None |
|---|---|---|---|---|---|---|
| Refractive index | MD | 1.53 | 1.52 | 1.53 | 1.52 | 1.62 |

| | | | | | |
|---|---|---|---|---|---|
| TD | 1.53 | 1.56 | 1.53 | 1.56 | 1.62 |

| | | | | | |
|---|---|---|---|---|---|
| Tensile modulus (Gpa) | 4.0 | 5.7 | 3.9 | 5.7 | 5.7 |
| Total light | 91.5 | 91.4 | 91.4 | 89.8 | 88.2 |
| transmittance (%) | | | | | |
| YI | 0.7 | 1.8 | 1.8 | −0.9 | 1.4 |
| ΔYI₁ | 9.7 | 0.6 | 0.6 | ND | 4.5 |

The films of Examples 1 to 6 containing a bluing agent and an ultraviolet absorber exhibited high transparency with a total light transmittance of 90% or more, had little coloring with YI of 1.0 or less, and exhibited excellent light-resistance with ΔYI of 1.8 or less. The films of Examples 1 to 6 were placed on white paper, and the presence or absence of coloring was visually checked. As a result, in all cases, the change from white was small in degree.

The film of Comparative Example 1 containing no bluing agent or ultraviolet absorber had a higher total light transmittance, a smaller YI, and excellent transparency than those of Example 1, but was inferior in light-resistance because it contains no ultraviolet absorber, and showed a large ΔYI.

The films of Comparative Examples 2 and 3 containing an ultraviolet absorber and containing no bluing agent exhibited high total light transmittance equivalent to that of Comparative Example 1, but had a large YI, and when the films were placed on white paper and visually checked for the presence or absence of coloring, the films were visually recognized as colored in yellow. In Comparative Example 4 in which the amount of the bluing agent was 80 ppm, YI was reduced as compared with Comparative Examples 2 and 3, but the total light transmittance was less than 90%. When the film of Comparative Example 4 was placed on white paper and the presence or absence of coloring was visually checked, the film was visually recognized as colored in blue.

From the comparison between Examples 2, 5, and 6 and Comparative Examples 3 and 4, it can be seen that as the amount of the bluing agent increases, YI tends to decrease, and the total light transmittance tends to decrease.

From the comparison of Examples 2 and 3, it can be seen that YI increases as the amount of the ultraviolet absorber increases, but ΔYI decreases, and light-resistance tends to improve. ΔYI when the film of Example 2 was irradiated with ultraviolet rays from the support surface side was smaller than ΔYI when the film was irradiated with ultraviolet rays from the air surface side. It is considered that in the film formed by the solution method, the ultraviolet absorber is unevenly distributed on the support surface side, and thus when ultraviolet rays are applied from the support surface side, the amount of ultraviolet rays absorbed by the ultraviolet absorber is large, the amount of ultraviolet rays absorbed by the resin is relatively small, deterioration of the resin due to the ultraviolet rays is suppressed, and ΔYI is reduced as compared with the case where ultraviolet rays are applied from the air surface side.

The film of Comparative Example 5 containing only a polyimide had a refractive index of more than 1.60, a low total light transmittance, and poor transparency. In Comparative Example 5, coloring was suppressed by reducing the amount of the ultraviolet absorber as compared with Example 4. Thus, Comparative Example 5 was inferior in light-resistance and exhibited larger ΔYI.

From the above results, it is found that when a mixed resin film of a polyimide-based resin and another resin (acryl-based resin) is used as the transparent film, YI of the transparent film is reduced, the refractive index is reduced, and thus, the total light transmittance is increased, and YI can be further reduced by adding a bluing agent.

Since the mixed resin of the polyimide-based resin and another resin has a smaller YI than the case of using the polyimide-based resin alone, the amount of the bluing agent can be reduced, which also contributes to improvement of the total light transmittance. In addition, since the mixed resin of the polyimide-based resin and another resin has a lower ratio of the polyimide-based resin than the case of the polyimide-based resin alone, it is possible to realize excellent light-resistance even when the amount of the ultraviolet absorber is small. The fact that the light absorption in a short wavelength range of visible light with the ultraviolet absorber can be reduced because the amount of the ultraviolet absorber is small is also considered to contribute to improvement of the total light transmittance and reduction of YI (neutralization of hue).

### [Production of Hard Coat Film]

### <Preparation of Acryl-Based Hard Coat Composition>

To 100 parts by weight of dipentaerythritol hexaacrylate (“ARONIX M-403” manufactured by TOAGOSEI CO., LTD.), 2 parts by weight of a photoradical polymerization initiator (“Omnirad 184” manufactured by IGM Resins) and 0.25 parts by weight of a polyether-modified silicone-based leveling agent (“BYK-300” manufactured by BYK) were added, and propylene glycol monomethyl ether was added as a diluent solvent, whereby an acryl-based hard coat composition having a solid content of 50 wt % was obtained.

### <Siloxane-Based Hard Coat Composition>

A reaction vessel equipped with a thermometer, a stirrer, and a reflux condenser was charged with 66.5 g (270 mmol) of 2-(3,4-epoxycyclohexyl)ethyltrimethoxysilane (“SILQUEST A-186” manufactured by Momentive Performance Materials Inc.) and 16.5 g of 1-methoxy-2-propanol (PGME), and the mixture was homogeneously stirred. To the mixed solution, a solution obtained by dissolving 0.039 g (0.405 mmol) of magnesium chloride as a catalyst in a mixed solution of 9.7 g (539 mmol) of water and 5.8 g of methanol was added dropwise over 5 minutes, and the mixture was stirred to be homogeneous. Thereafter, the solution was heated to 80° C., and a polycondensation reaction was performed for 6 hours with stirring. After completion of the reaction, the solvent and water were distilled off by a rotary evaporator, whereby a condensate of a silane compound (polyorganosiloxane compound) was obtained.

The polystyrene-equivalent weight-average molecular weight measured by GPC apparatus “HLC-8220GPC” (column: TSKgel GMH_{XL}×2 columns, TSKgel G3000H_{XL}, TSKgel G2000H_{XL}) manufactured by TOSOH CORPORATION was 3000. The residual ratio of epoxy groups calculated from a ¹H-NMR spectrum measured using heavy acetone as a solvent with 400 MHz-NMR manufactured by Bruker was not less than 95%.

To 100 parts by weight of the polyorganosiloxane compound, 2 parts by weight of a sulfonium-based photoacid generator (“CPI-101A” manufactured by San-Apro Ltd.) and 0.25 parts by weight of a polyether-modified silicone-based leveling agent (“BYK-300” manufactured by BYK) was added, and propylene glycol monomethyl ether was added as a diluent solvent, whereby a siloxane-based hard coat composition having a solid content of 50 wt % was obtained.

### EXAMPLE 11

The acryl-based hard coat composition was applied onto the support surface of the film (content of bluing agent: 20 ppm) produced in Example 2 with a coater such that the dry film thickness was 10 μm, and the solvent was removed at 120° C. Thereafter, the hard coat resin composition was cured by irradiation with ultraviolet rays in a nitrogen atmosphere using a high-pressure mercury lamp such that the integrated light amount was 1950 mJ/cm², whereby a hard coat film having a 10 μm-thick acryl-based hard coat layer was obtained.

### EXAMPLE 12

The siloxane-based hard coat composition was applied onto the support surface of the film produced in Example 2 with a coater such that the dry film thickness was 10 μm, and the solvent was removed at 120° C. Thereafter, the hard coat resin composition was cured by irradiation with ultraviolet rays in an air atmosphere using a high-pressure mercury lamp such that the integrated light amount was 1950 mJ/cm², whereby a hard coat film having a 10 μm-thick siloxane-based hard coat layer was obtained.

### EXAMPLE 13

A hard coat film having the acryl-based hard coat layer having a thickness of 10 μm was obtained in the same manner as in Example 11 except that the film produced in Example 6 (content of bluing agent: 60 ppm) was used instead of the film produced in Example 2.

### EXAMPLE 14

A hard coat film including the acryl-based hard coat layer was obtained in the same manner as in Example 13 except that the thickness of the hard coat layer was changed to 5 μm.

### EXAMPLE 15

A hard coat film including the siloxane-based hard coat layer having a thickness of 10 μm was obtained in the same manner as in Example 12 except that the film produced in Example 6 was used instead of the film produced in Example 2.

### EXAMPLE 16

A hard coat film including the siloxane-based hard coat layer was obtained in the same manner as in Example 15 except that the thickness of the hard coat layer was changed to 20 μm. [Evaluation of hard coat film]

For the hard coat films of Examples 11 to 16, the total light transmittance, the yellowness index (YI), and the light-resistance obtained through the carbon arc test were evaluated in the same manner as described above. The pencil hardness of the hard coat layer surface was evaluated with a load of 750 g according to JIS K5600.

The configuration and evaluation results of the hard coat films of Examples 11 to 16 are shown in Table 3 together with the evaluation results of the films of Examples 2 and 6 having no hard coat layer.

TABLE 3

| Example | Example | Example | Example | Example | Example | Example | Example |
|---|---|---|---|---|---|---|---|
| 2 | 11 | 12 | 6 | 13 | 14 | 15 | 16 |

| Transparent | PI 1 | | 55 | |
|---|---|---|---|---|
| film | Acryl | | 45 | |
| composition | Bluing agent | Plast blue 8590 | 0.002 | 0.006 |

| | | |
|---|---|---|
| Ultraviolet absorber | LA-31RG | 5.6 |

| | | | | | | | |
|---|---|---|---|---|---|---|---|
| Hard coat | Curable resin | Acryl | Siloxane | Acryl | Acryl | Siloxane | Siloxane |
| layer | Thickness (μm) | 10 | 10 | 10 | 5 | 10 | 20 |

| | | | | | | | | |
|---|---|---|---|---|---|---|---|---|
| Total light transmittance (%) | 91.0 | 91.2 | 91.1 | 90.2 | 90.2 | 90.2 | 90.2 | 90.0 |
| YI | 0.9 | 1.0 | 1.1 | −0.3 | 0.1 | −0.1 | 0.2 | 0.4 |
| ΔYI | 0.8 | 0.8 | 0.9 | 1.0 | 1.1 | 0.9 | 1.2 | 1.3 |
| Pencil hardness | ND | 4H | 4H | ND | 4H | 4H | 4H | 6H |

The hard coat films of Examples 11 and 12 had YI slightly larger than that of the transparent film of Example 2, but had higher total light transmittance than that of Example 2, and had light-resistance equivalent to that of Example 2. The same tendency was observed in comparison between Example 6 and Examples 13 to 16.

### [Study of Bluing Agent]

### EXAMPLES 21 TO 29

A film having a thickness of 50 μm was obtained in the same manner as in Example 1 except that the type and amount of the bluing agent (weight ratio with respect to 100 parts by weight of the total of the resin components) were changed as shown in Table 4. “Plast Blue 8590”, “Plast Blue 8580”, “Plast Violet 8840”, “Plast Blue 8520”, and “Plast Blue 8516” are all anthraquinone-based dyes manufactured by Arimoto Chemical Co., Ltd. “FS Blue 1556” is a blue dye (Disperse Blue 354:2-[4-(Dihexylamino)-2-methylbenzylidene]-3-(dicyanomethylene)-2,3-dihydrobenzo[b]thiophene 1,1-dioxide) manufactured by Arimoto Chemical Co., Ltd. “ET 4B403” (manufactured by Dainichiseika Color & Chemicals Mfg. Co., Ltd.) and “BL-G207” (manufactured by Sanyo Color Works, LTD.) are phthalocyanine-based pigments, and “Ultramarine Blue 51” (manufactured by Holliday Pigments) is ultramarine blue (inorganic pigment).

### [Evaluations]

For the films of Examples 21 to 29, the total light transmittance, the haze, and the yellowness index (YI) were evaluated in the same manner as described above. In addition, for the light-resistance, the following evaluations were performed.

### <Transmission Spectrum>

A transmission spectrum in a wavelength range of 350 to 850 nm was measured by an ultraviolet-visible near-infrared spectrophotometer (“V-770” manufactured by JASCO Corporation), and a wavelength (maximum absorption wavelength) Amax at which the transmittance became the minimum in a wavelength range of 500 to 700 nm (absorption band of bluing agent) and a transmittance To at the maximum absorption wavelength were determined. When there were a plurality of absorption maxima in the range of 500 to 700 nm, the absorption maximum wavelength of the shortest wavelength was defined as Amax.

### <Xenon Light-Resistance Test>

Using a xenon weather meter (“SX-75” manufactured by Suga Test Instruments Co., Ltd.), irradiation was performed for 200 hours from the support surface side of the film under the conditions of ultraviolet rays: a xenon light source, ultraviolet ray (wavelength: 300 nm to 400 nm) irradiance: 180 W/m², black panel temperature: 80° C., and no rain. After the ultraviolet irradiation, the yellowness index and the transmission spectrum were measured, and the change amount ΔYI₂=YI₂−YI₀ of the yellowness index before and after the ultraviolet irradiation and the change amount ΔT₂=T₂−T₀ of the transmittance at λₘₐₓ were calculated.

The types and amounts of the bluing agent of the films of Examples 21 to 29 and the evaluation results are shown in Table 4.

TABLE 4

| | | Example | Example | Example | Example | Example | Example | Example | Example | Example |
|---|---|---|---|---|---|---|---|---|---|---|
| | | 21 | 22 | 23 | 24 | 25 | 26 | 27 | 28 | 29 |
| Bluing | Type | ET 4B403 | BL-G207 | Ultramarine | Plast | Plast | Plast | Plast | Plast | FS |
| agent | | | | Blue 51 | Blue 8590 | Blue 8580 | Violet 8840 | Blue 8520 | Blue 8516 | Blue 1556 |
| | Amount | 0.021 | 0.024 | 0.095 | 0.004 | 0.004 | 0.004 | 0.004 | 0.004 | 0.004 |

| | | | | | | | | | |
|---|---|---|---|---|---|---|---|---|---|
| Haze | 0.5 | 0.6 | 0.9 | 0.3 | 0.2 | 0.2 | 0.3 | 0.2 | 0.2 |
| Total light transmittance (%) | 90.2 | 90.2 | 90.1 | 90.5 | 90.3 | 90.1 | 90.3 | 90.1 | 88.7 |
| YI | −0.7 | −0.3 | −0.4 | 0.1 | −0.1 | 0.2 | 0.1 | −0.6 | −3.1 |
| ΔYI₂ | 1.4 | 1.4 | 1.4 | 2.0 | 2.1 | 1.7 | 1.8 | 2.7 | 4.6 |
| λₘₐₓ (nm) | 629 | 604 | 565 | 589 | 589 | 578 | 580 | 600 | 614 |
| T₀ (%) | 88.9 | 89.4 | 89.7 | 89.9 | 89.6 | 89.7 | 89.9 | 89.0 | 85.7 |
| T₀ (%) | 89.0 | 89.5 | 89.7 | 90.4 | 90.4 | 90.1 | 90.3 | 90.5 | 89.8 |
| ΔT₂ | 0.1 | 0.1 | 0.0 | 0.5 | 0.8 | 0.4 | 0.4 | 1.5 | 4.1 |

In Examples 21 to 23 in which a pigment-based bluing agent was used, the change ΔYI₂ in yellowness index after the xenon light-resistance test, which is more severe than the carbon arc test, was smaller than ΔYI₂ in Examples 24 to 29 in which a dye-based bluing agent was used, and thus excellent light-resistance was exhibited. It is considered that excellent light-resistance was exhibited in Examples 21 to 23 because the transmittance change ΔT₂ of the maximum absorption wavelength of the bluing agent was smaller than that in Examples 24 to 29, and deterioration of the bluing agent in the xenon light-resistance test was suppressed.

On the other hand, Examples 24 to 29 had a lower haze than Examples 21 to 23, and it can be seen that the dye-based bluing agent is excellent from the viewpoint of transparency. In Examples 24 to 28 in which an anthraquinone-based dye was used as the bluing agent, ΔYI₂ and ΔT₂ were smaller than those in Example 29. Thus, it can be seen that the anthraquinone-based dye has high light-resistance among the dyes.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A transparent film comprising: a polyimide-based resin; and a bluing agent, wherein the transparent film has a total light transmittance of 90% or more.

2. The transparent film according to claim 1, further comprising a resin other than the polyimide-based resin.

3. The transparent film according to claim 1, further comprising an acryl-based resin.

4. The transparent film according to claim 3, wherein the acryl-based resin comprises methyl methacrylate as a main structural unit.

5. The transparent film according to claim 3, wherein an amount of the acryl-based resin is 2 to 98 parts by weight with respect to 100 parts by weight of the total of the polyimide-based resin and the acryl-based resin.

6. The transparent film according to claim 1, further comprising an ultraviolet absorber, wherein the transparent film has a yellowness index of −1.0 or more and 1.0 or less.

7. The transparent film according to claim 6, wherein an amount of the ultraviolet absorber is 1 part by weight or more with respect to 100 parts by weight of the total of resin components.

8. The transparent film according to claim 1, wherein the bluing agent is an anthraquinone-based compound.

9. The transparent film according to claim 1, wherein the bluing agent is selected from the group consisting of phthalocyanine-based compounds, ultramarine blue and combinations thereof.

10. The transparent film according to claim 1, wherein a content of the bluing agent is 20 ppm or more.

11. The transparent film according to claim 1, having a refractive index of 1.60 or less.

12. The transparent film according to claim 11, wherein an amount of silicon oxide is 5 parts by weight or less with respect to 100 parts by weight of the total of resin components.

13. The transparent film according to claim 1, wherein the polyimide-based resin comprises a tetracarboxylic dianhydride-derived structure and a diamine-derived structure, wherein:
the tetracarboxylic dianhydride-derived structure is derived from an alicyclic tetracarboxylic dianhydride and a fluorine-containing aromatic tetracarboxylic dianhydride, and
the diamine-derived structure is derived from a fluorine-containing diamine.

14. The transparent film according to claim 1, having a thickness of 20 μm or more.

15. A hard coat film comprising: the transparent film according to claim 1; and a hard coat layer disposed on at least one main surface of the transparent film.

16. A display comprising the transparent film according to claim 1.

17. The transparent film according to claim 4, wherein an amount of the acryl-based resin is 2 to 98 parts by weight with respect to 100 parts by weight of the total of the polyimide-based resin and the acryl-based resin.

18. The transparent film according to claim 2, further comprising an ultraviolet absorber, wherein the transparent film has a yellowness index of −1.0 or more and 1.0 or less.

19. The transparent film according to claim 2, wherein the bluing agent is an anthraquinone-based compound.

20. The transparent film according to claim 2, wherein the bluing agent is selected from the group consisting of phthalocyanine-based compounds, ultramarine blue and combinations thereof.
